(19) United States
(12) Patent Application Publication
(10) Pub. No.: US 2006/0053848 A1
(43) Pub. Date: Mar. 16, 2006

(54) Vehicle ignition lock

(76) Inventors: Riad Ghabra, Dearborn Heights, MI (US); Qingfeng Tang, Novi, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/940,829

(22) Filed: Sep. 14, 2004

(51) Int. Cl. B60R 25/02; E05B 11/00

(52) U.S. Cl. 70/252; 70/389

(57) ABSTRACT

An ignition lock assembly mounts to a vehicle and operatively engages an ignition system. The ignition lock assembly includes a lock assembly having a recess for receiving a key shank. The recess has a retention device that will lock a portion of a knob in the recess when the portion of the knob is inserted in the recess and will allow removal of a key from the recess after a portion of the key is inserted into the recess. In this way, the same lock assembly can be used for a vehicle model that offers an option of conventional key ignition starting or passive go starting.

### BACKGROUND OF THE INVENTION

The present invention relates to vehicle ignition locks, and in particular to vehicle ignition locks employed with vehicle models that may employ either a conventional key or a passive go system.

It is known in the automotive industry to provide for passive go systems. These systems typically include a remote transceiver, such as a fob or a card, that will easily fit within a pocket or wallet of a vehicle operator. Such passive go systems also typically include a vehicle mounted starter switch or button to enable a vehicle operator to indicate a desire to turn the engine on and off. For starting the engine, after the switch or button is actuated, an electronic control module/transceiver in communication with the switch will automatically transmit a passive entry challenge signal. Upon receipt of the challenge signal, the fob or card automatically determines if the challenge signal is valid, and, if so, transmits a radio frequency response signal that includes a unique identification code. The vehicle control module compares the identification code with the codes of authorized fobs or cards and if a match is found, then an engine immobilizer function is disabled (that is, the vehicle engine starting is enabled), and the engine is automatically started.

It is also known in the automotive industry to provide for the more conventional key initiated ignition systems, where a vehicle operator must insert a key in to an ignition lock assembly and turn it in order to start the vehicle. Such conventional key operated systems may employ a simple key that allows the engine to start and operate merely when the teeth on the key shank match the tumbler lock set in the ignition lock assembly, thereby allowing a lock assembly to turn relative to a lock housing. These systems may alternatively employ a key that also includes a chip with a transceiver and identification code that communicates with an engine immobilizer system—thus appearing to the vehicle operator to operate as a conventional key start ignition system, while providing an immobilizing function somewhat similar to the passive go systems.

However, while both passive go and the more conventional key operated ignition systems work well, issues arise when it is desired to produce a particular model of vehicle that offers both types. For a particular model of vehicle that offers both a more conventional key operated ignition lock, as well as a passive go system as a vehicle upgrade option, the two employ different components. That is, while the more conventional key operated ignition lock employs the conventional lock housing and lock assembly with the lock tumbler set, the passive go system typically employs a separate switch assembly for initiating passive go that is quite different from the conventional ignition lock. This adds to the number of components, as well as adding to the complexity and cost, for this particular model of vehicle offering both options. For example, on the vehicles that do not include the upgrade option (that is, the vehicle with the more conventional key operated ignition lock), it is not desirable to have the passive go starter switch since it won't perform any function on this key operated vehicle.

Thus, it is desirable to have ignition lock systems and ignition lock assemblies that allow for both conventional key operated ignition locks as well as passive go systems as an option, while minimizing the number of different components and cost of offering both types of operation on a single vehicle model.

### SUMMARY OF THE INVENTION

In its embodiments, the present invention contemplates an ignition lock assembly adapted to mount to a vehicle and operatively engage an ignition system. The ignition lock assembly may have a lock assembly including a recess, adapted to receive a key shank, and a retention device, adapted to lock a portion of a knob in the recess when the portion of the knob is inserted in the recess and adapted to allow removal of a key from the recess after a portion of the key is inserted into the recess.

The present invention also contemplates an ignition lock system for use with a vehicle having an engine control unit. The ignition lock system may include a lock assembly including a recess, adapted to receive a key shank, and a retention device, adapted to lock a portion of a knob in the recess when the portion of the knob is inserted in the recess and adapted to allow removal of a key from the recess after a portion of the key is inserted into the recess. The ignition lock system may also include at least one of an engine immobilizer controller and a passive go controller adapted to operatively engage the engine control unit, an ignition system operatively engaging the lock assembly and adapted to operatively engage the engine control unit, and an interrogation signal producer adapted to be in communication with the engine control unit.

An advantage of an embodiment of the present invention is that the lock assembly and lock housing can be exactly the same for both a key operated ignition lock and for a passive go system offered as an option on the same vehicle model or platform.

An additional advantage of an embodiment of the present invention is that, for vehicle equipped with a passive go option, the knob is always in the vehicle, thus allowing a vehicle operator to quickly and easily start a vehicle engine.

Another advantage of an embodiment of the present invention is that, for a vehicle with a key operated ignition option, there is no extra (and unused) passive go knob or button.

### BRIEF DESCRIPTION OF THE DRAWINGS

FIG. 1 is a schematic, perspective view of a portion of an ignition lock assembly and associated key in accordance with a first embodiment of the present invention.

FIG. 2 is a schematic, perspective view of the first embodiment, but showing a portion of the ignition lock assembly and an associated knob.

FIG. 3 is a schematic, elevation view of the first embodiment, but with the knob shown within a recess and with a lock tumbler set illustrated.

FIG. 4 is a schematic, elevation view of the first embodiment, illustrating a portion of the ignition lock assembly and the key employed with an engine immobilizer system.

FIG. 5 is a schematic, elevation view of the first embodiment, illustrating a portion of the ignition lock assembly and knob employed with a passive go system.

FIG. 6 is a schematic, plan view of a portion of an ignition lock assembly and associated key in accordance with a second embodiment of the present invention.

FIG. 7 is a schematic, plan view of the second embodiment, but showing a portion of the ignition lock assembly and an associated knob.

### DETAILED DESCRIPTION

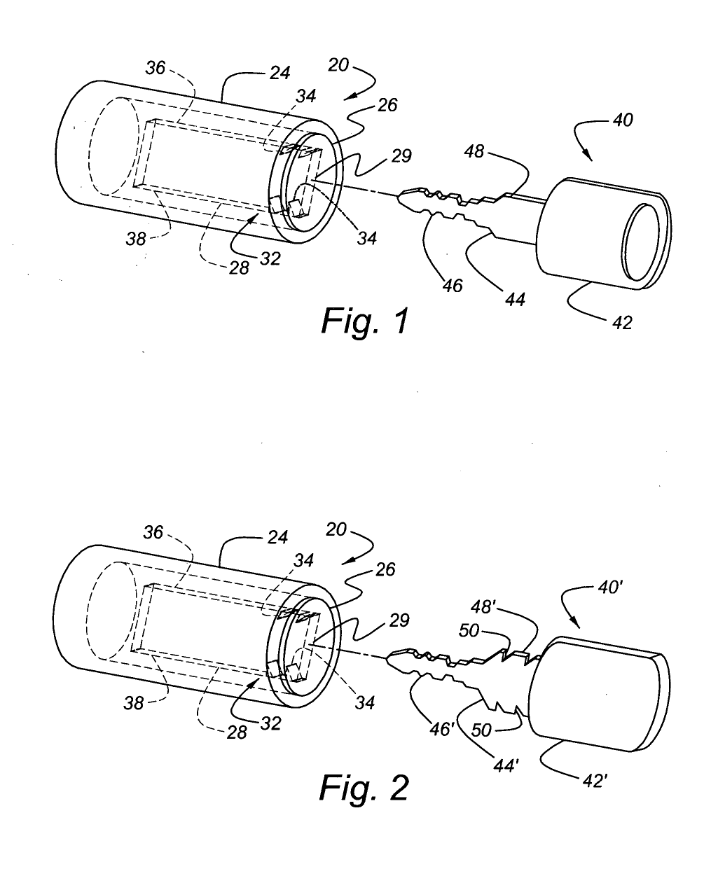

FIGS. 1-5 illustrate an ignition lock assembly, indicated generally at 20, that is employed as part of an ignition control system, indicated generally at 22. The ignition lock assembly 20 includes a lock housing 24, which is preferably conventionally mounted on a vehicle steering column (not shown), but may be mounted at other vehicle locations, as is known to those skilled in the art. In the figures discussed herein, the various components that form a part of or interact with the present invention have been shown in a simplified manner with various individual components omitted so that the teachings of the invention can be easily recognized.

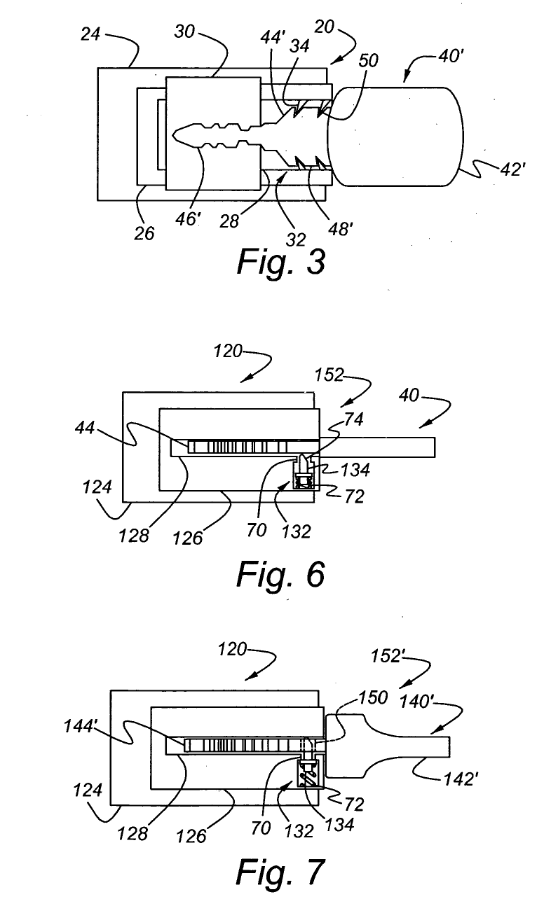

A lock assembly 26 (only illustrated in FIGS. 3-5) is mounted within and is selectively rotatable relative to the lock housing 24. The lock assembly 26 includes a slotted recess 28 extending at least part of the way therethrough, with the slotted recess 28 sized for receiving a shank, discussed below, through a key opening 29. A lock tumbler set 30 extends through a portion of the lock assembly 26, and its recess 28, and into the lock housing 24. The lock tumbler set 30 is preferably conventional and known to those skilled in the art and so will not be disclosed in any detail herein.

A retention device 32, which includes four retention barbs 34 extending into the recess 28, is also included in the lock assembly 26. Two retention barbs 34 extend from a top surface 36 of the recess 28 and two retention barbs 34 extend from an opposed bottom surface 38 of the recess 28. While four barbs 34 are illustrated by way of example in the figures, it is understood that the actual number of barbs employed can be only one or can be many. Preferably, each barb 34 angles away from the key opening 29 as it extends into the recess 28.

A key 40 includes a head 42 connected to a shank 44. The edges of the shank 44 include teeth 46 and relatively smooth surfaces 48 between the teeth 46 and the head 42. The shank 44 is sized and shaped to slide easily into the recess 28 of the lock assembly 26 until the teeth 46 engage the lock tumbler set 30. The width of the shank 44 at the surface 48 is preferably narrow enough that the surface 48 makes only minimal surface contact with the ends of the retention barbs 34. In this way, the key shank 44 can be easily inserted and removed from the recess 28 many times without the retention barbs 34 interfering with this motion.

A knob 40′ also has a shank portion 44′ with teeth 46′ that are also formed to match the lock tumbler set 30 built into the ignition lock assembly 20. The knob 40′ has a head portion 42′ that is preferably shaped for ease of manipulation by a vehicle operator. Along the edges 48′, between the teeth 46′ and head portion 42′, the knob 40′ includes four retention slots 50. The retention slots 50 are each sized and spaced to engage a respective one of the retention barbs 34 when the shank portion 44′ is inserted into the recess 28 of the lock assembly 26. In the preferred configuration, the retention barbs 34 may elastically flex as they are engaged by the edges 48′ and then snap into the retention slots 50 when the knob 40′ is fully inserted into the recess 28. The purpose of the retention device 32 is that the shank portion 44′ of the knob 40′ is inserted into the recess 28 only once and remains essentially permanently in the lock assembly 26. In this way, the same lock housing 24 and lock assembly 26 can be employed for a particular vehicle model or platform—even if the this model or platform offers both the more conventional key operated system and the upgrade option of a passive go ignition system.

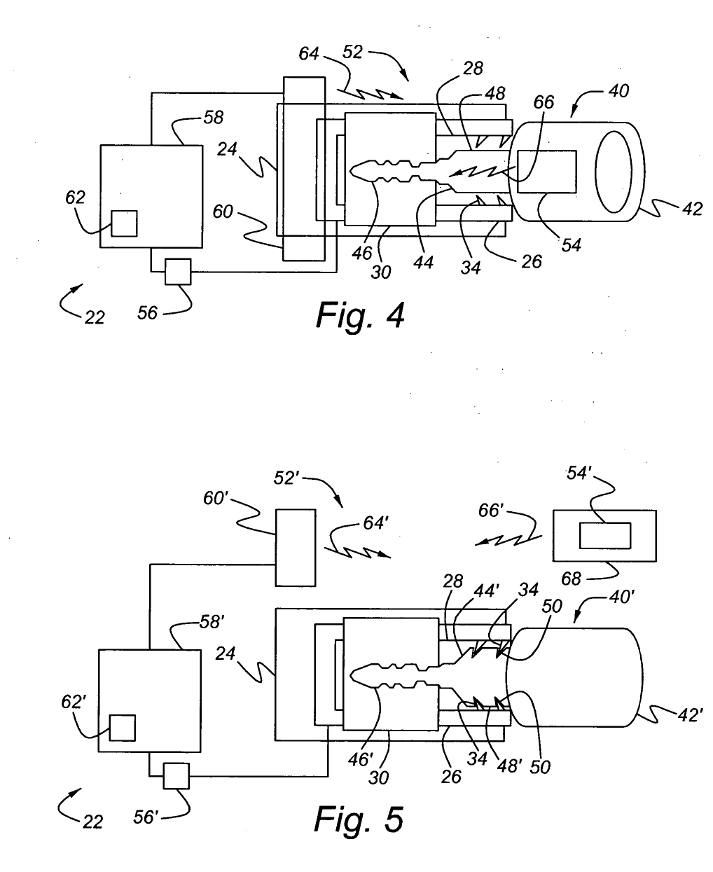

The more conventional key operated system arrangement, indicated generally at 52, is shown in FIG. 4. This system arrangement 52 preferably includes the key 40 with an engine immobilizer chip 54 built into its head 42. The individual components of the immobilizer chip 54 are not specifically illustrated herein since they are well known to those skilled in the art. The shank 44 of the key slides in the recess 28 of the lock assembly 26, with the teeth 46 engaging the lock tumbler set 30, but without the retention barbs 34 engaging the smooth surfaces 48 along the edges so that the key 40 can be easily removed from the lock assembly 26.

The lock assembly 26 engages an ignition system 56, preferably in a conventional fashion. The ignition system 56 may include an ignition switch (not shown), which may be separate from or integral with the ignition lock assembly 26, and an ignition control module (not shown), which may be separate from or integral with an engine control unit 58, but since both are known to those skilled in the art, will not be shown in detail herein. An induction coil 60 is preferably mounted around the lock housing 24 and is preferably connected to and controlled by the engine control unit 58. The engine control unit 58 preferably includes an engine immobilizer control 62, as is known to those skilled in the art.

The more conventional key operated system arrangement 52 illustrated in FIG. 4 may operate by the induction coil 60 being activated by the engine control unit 58 to broadcast an interrogation signal, indicated generally at 64, in response to the turning of the key 40 in the lock assembly 26. Interrogation signals broadcast by the induction coil 60 are received by the immobilizer chip 54, which will generate a response signal, indicated generally at 66, that includes a unique identification code. The engine control unit 58 compares the identification code with the codes of authorized keys 40 and if a match is found, then an engine immobilizer control 62 is disabled (that is, the vehicle engine starting is enabled). The description of the engine immobilization just described is merely an example, and, since such systems and methods are known to those skilled in the art, will not be discussed in any more detail herein.

Alternatively, if so desired, the key 40 may be even more conventional, with the head 42 not including a chip and the vehicle not including an engine immobilizer system. Thus, merely inserting the appropriate key shank 44 into the lock tumblers set 30 will release the lock assembly 26 relative to the lock housing 24, so that turning the key 40 will allow the engine to start.

The passive go system arrangement, indicated generally at 52′, is illustrated in FIG. 5. This system arrangement 52′ preferably includes a remote authenticator 68, which may take any convenient form, for example, the form of a fob that one may attach to a key ring and fit easily within a pocket on ones clothing or it may take the form of a credit card shaped object that will fit easily into a wallet. The remote authenticator 68 includes electronic circuitry 54′ for communicating with a passive go transceiver/antenna 60′ in order to allow for the functioning of the passive engine starting. The electronic circuitry may include a fob controller, a transceiver, an antenna, and/or a battery, which are not specifically illustrated herein as this circuitry and these components are known to those skilled in the art.

In this system arrangement 52, the shank 44′ of the Knob 40′ slides in the recess 28 of the lock assembly 26, with the teeth 46′ engaging the lock tumbler set 30. As the shank 44′ is slid into the recess 28, the retention barbs 34 slide along the edges 48′ until they engage the retention slots 50. Once engaged, the knob 40′ cannot be removed from the lock assembly 26. Accordingly, while the lock housing 24 and lock assembly 26 are the same for both the passive go arrangement 52′ and the more conventional key operated system arrangement 52, the vehicle operator will see the two arrangements as operating quite differently.

In the passive go system arrangement 52′, the lock assembly 26 may also′ engage an ignition system 56′ in a generally conventional fashion. The ignition system 56′ may again include an ignition switch (not shown), which may be separate from or integral with the ignition lock assembly 26, and an ignition control module (not shown), which may be separate from or integral with an engine control unit 58′. A passive go transceiver/antenna 60′ may be mounted around the lock housing 24, as is the case with the key operated arrangement 52, but in general is preferably mounted at locations other than the vehicle steering column that are typically more desirable for communicating with the electronic circuitry 54′ on the remote authenticator 68. Such locations will not be specifically discussed as they are known to those skilled in the art. The passive go transceiver/antenna 60′ is also connected to and controlled by the engine control unit 58. The engine control unit 58′ preferably includes an integral passive go control 62′, as is known to those skilled in the art. Alternatively, a passive go electronic module may be housed separate from but in communication with the engine control unit 58′.

The passive go system arrangement 52′ illustrated in FIG. 5 may operate by an interrogation signal, indicated generally at 64′, being broadcast by the transceiver/antenna 60′ in response to the turning of the knob 40′ in the lock assembly 26. Interrogation signals broadcast by the transceiver/antenna 60′ are received by the remote authenticator 68, and if valid, the electronic circuitry 54′ will generate a response signal, indicated generally at 66′, that includes a unique identification code. The engine control unit 58′ compares the identification code with the codes of authorized remote authenticators 68 and if a match is found, then a passive go control function is enabled and the engine is started. The description of the passive go just described is merely an example, and, since such systems and methods are known to those skilled in the art, will not be discussed in any more detail herein.

Thus, the passive go system arrangement 52′ will allow a vehicle operator to enter and start the vehicle engine (not shown), as well as stop the engine and exit the vehicle, without ever inserting or removing a key, or any other device, into or out of any vehicle component.

FIGS. 6 and 7 illustrate an alternate embodiment of the present invention, with FIG. 6 showing the more conventional key operated system arrangement 152 and FIG. 7 showing the passive go system arrangement 152′. This embodiment is essentially the same as the first, but with a different retention device 132 for the ignition lock assembly 120. The head 142′ of the knob 140′ is also shaped differently in order to illustrate that, since the knob 140′ remains in the vehicle at all times (and thus does not need a convenient shape for fitting in a purse or a clothing pocket), it can be any shape that is desirable for making the knob easy to rotate while in the lock assembly 126.

As with the first embodiment, the lock assembly 126 mounts within the lock housing 124 and includes the recess 128 that can receive either the shank 44 of the key 40 or the shank 144′ of the knob 140′. But in this embodiment, the retention device 132 includes a retention pin 134, which is received through an opening 70 in the recess 128, and a spring 72, which biases the retention pin 134 into the recess 128.

Preferably, the retention pin 134 has a tapered tip 74, making it generally easier to insert and remove the shank 44 of the key 40 if the lock assembly 26 is being employed with a key operated arrangement. For this arrangement, as the key shank 44 is inserted into the recess 128, it will push the retention pin 134 out of the recess 128 against the bias of the spring 72. Thus, the vehicle operator having a vehicle with the key operated arrangement will not even notice any difference in operation from a conventional key operated system.

For this second embodiment, the knob 140′ includes a retention hole 150 through its shank 144′ that is located to align with the retention pin 134 when the knob 140′ is fully seated in the recess 128. Consequently, as the shank 144′ of the knob 140′ is beginning to be inserted into the recess 128, the shank 144′ will push the retention pin 134 out of the recess 128. Then, as the knob 140′ is fully inserted, the retention hole 150 will align with the retention pin 134, allowing the spring 72 to push the retention pin 134 into the retention hole 150. The knob 140′ is now locked into the lock assembly 126 and ready to be manipulated by a vehicle operator any time it is desired to start or stop the vehicle engine.

While certain embodiments of the present invention have been described in detail, those familiar with the art to which this invention relates will recognize various alternative designs and embodiments for practicing the invention as defined by the following claims. For example, the retention pin may be located/oriented in the position shown for the barbs with the knob shank including a corresponding hole where one of the retention slots are shown. Also, the barbs may be located and oriented in the position shown for the retention pin with the knob shank including retention slots where the retention hole is shown. Moreover, the pin/retention hole configuration can be reversed, with the knob including a pin and the recess including a retention hole within which the pin will slide; and the barb/retention slot configuration can also be reversed, with the knob including barbs extending therefrom and the recess including retention slots within which the barbs will be received. Or, a different device, other than a pin or barbs, may be employed that will retain the knob while allowing the key to be repeatedly inserted and removed from the lock assembly. In addition, the knob may be a multi-piece mechanism that allows a push button motion by the operator to be converted into the rotational motion of the shank portion of the knob in the lock assembly.

What is claimed is:

1. An ignition lock assembly adapted to mount to a vehicle and operatively engage an ignition system, the ignition lock assembly comprising a lock assembly including a recess, adapted to receive a key shank, and a retention device, adapted to lock a portion of a knob in the recess when the portion of the knob is inserted in the recess and adapted to allow removal of a key from the recess after a portion of the key is inserted into the recess.

2. The ignition lock assembly of claim 1 wherein the retention device includes a retention pin, adapted to operatively engage a retention hole in the knob and slide along a surface of the key, and a biasing member that biases the retention pin into the recess.

3. The ignition lock assembly of claim 2 wherein the retention pin includes a tapered tip adapted for slidingly engaging the surface of the key.

4. The ignition lock assembly of claim 2 wherein the biasing member is a coil spring.

5. The ignition lock assembly of claim 1 wherein the retention device includes a retention barb, extending into the recess, and adapted to operatively engage a retention slot in the knob and slide along a surface of the key without locking engagement to the surface of the key.

6. The ignition lock assembly of claim 5 wherein the retention device includes a second retention barb, extending into the recess, and adapted to operatively engage a second retention slot in the knob.

7. The ignition lock assembly of claim 6 wherein the retention barb and the second retention barb extend from opposed surfaces of the recess.

8. The ignition lock assembly of claim 1 further including lock housing adapted to be fixed to the vehicle, with the lock assembly being located generally within the lock housing and adapted to be selectively rotatable relative to the lock housing when a key shank having a predetermined shape is inserted into the recess.

9. An ignition lock assembly adapted to mount to a vehicle and operatively engage an ignition system, the ignition lock assembly comprising:
a lock assembly including a recess adapted to receive a key shank and a retention device; and
a knob having a key shank portion, located in the recess and having teeth on the key shank portion adapted to operatively engage a lock tumbler set, a knob portion, extending from the recess and adapted to be manipulated by a vehicle user, and an engager operatively engaging the retention device to thereby prevent the knob from being removed from the recess.

10. The ignition lock assembly of claim 9 wherein the engager includes a retention hole through the key shank portion, and the retention device includes a retention pin and a biasing member that biases the retention pin into the retention hole.

11. The ignition lock assembly of claim 10 wherein the retention pin includes a tapered point.

12. The ignition lock assembly of claim 10 wherein the biasing member is a coil spring.

13. The ignition lock assembly of claim 9 wherein the engager includes a retention slot in the key shank portion, and the retention device includes a retention barb extending into the retention slot.

14. The ignition lock assembly of claim 9 further including a lock housing adapted to be fixed to the vehicle, with the lock assembly located generally within the lock housing and rotatable relative to the lock housing when the key shank portion has a predetermined shape.

15. The ignition lock assembly of claim 14 wherein the predetermined shape of the key shank portion includes a plurality of teeth adapted to operatively engage a lock tumbler set to thereby allow rotation of the lock assembly relative to the lock housing.

16. An ignition lock system for use with a vehicle having an engine control unit, the ignition lock system comprising:
a lock assembly including a recess, adapted to receive a key shank, and a retention device, adapted to lock a portion of a knob in the recess when the portion of the knob is inserted in the recess and adapted to allow removal of a key from the recess after a portion of the key is inserted into the recess;
at least one of an engine immobilizer controller and a passive go controller adapted to operatively engage the engine control unit;
an ignition system operatively engaging the lock assembly and adapted to operatively engage the engine control unit; and
an interrogation signal producer adapted to be in communication with the engine control unit.

17. The ignition lock system of claim 16 wherein the retention device includes a retention pin, adapted to operatively engage a retention hole in the knob and slide along a surface of the key, and a biasing member that biases the retention pin into the recess.

18. The ignition lock system of claim 16 wherein the retention device includes a retention barb, extending into the recess, and adapted to operatively engage a retention slot in the knob and slide along a surface of the key without locking engagement to the surface of the key.

19. The ignition lock system of claim 16 further including an engine immobilizer chip adapted to be located in the key and receive interrogation signals from the interrogation signal producer.

20. The ignition lock system of claim 16 further including a remote authenticator having an electronic circuit adapted to receive interrogation signals from the interrogation signal producer.
